(19) United States
(12) Patent Application Publication
(10) Pub. No.: US 2026/0249399 A1
(43) Pub. Date: Aug. 27, 2026

(54) DEVICE FOR WELDING A CAP OF A CONTAINER SUITABLE FOR CONTAINING A MEDICINAL SUBSTANCE AND A WELDING METHOD THEREOF

(71) Applicant: ASEPTIC TECHNOLOGIES, Les Isnes (BE)

(72) Inventors: Patrick BALERIAUX, Ham-sur-Heure-Nalinnes (BE); Julien MARECHAL, Houston, TX (US)

(21) Appl. No.: 18/877,951

(22) PCT Filed: Jun. 13, 2023
(86) PCT No.: PCT/EP2023/065737

§ 371 Date: Dec. 20, 2024

(30) Foreign Application Priority Data
Jun. 21, 2022 (BE) 2022/5486

(51) Int. Cl. B23K 26/70; B23K 26/062; B23K 26/142; B23K 26/20; F16H 19/04

(52) U.S. Cl. CPC B23K 26/702; B23K 26/0626; B23K 26/142; B23K 26/206; F16H 19/04

(57) ABSTRACT

The disclosure relates to a device for welding a cap of a container suitable for containing a medicinal substance. The device comprises a laser for welding the container and a barrel defining a laser firing chamber. The barrel is movable between multiple positions including a container welding position and an unloaded position, a laser shutter, the barrel opening the shutter in the welding position and closing the shutter in the unloaded position, and a skirt capable of preventing or allowing the barrel to move between the unloaded position and the welding position. The disclosure also relates to a method for welding a container.

### TECHNICAL FIELD

This invention relates to a device for welding a cap of a container suitable for containing a medicinal substance and a welding method thereof.

### BACKGROUND

Containers suitable for containing a medicinal substance (such as vaccines) or other biological substances (such as cells) are provided with a hermetically sealed cap which can be pierced by a needle to introduce the substance into the container. Once the needle has been removed, the cap should be sealed again. For this, a laser can be used to weld the cap where the needle has pierced the cap.

The document DE10005593 describes a device for spot welding, but this device does not offer sufficient safety guarantees.

There is a safety issue with lasers, which can be dangerous if they are not actuated with care.

There is therefore a need for a safe device for welding a cap of a container.

### SUMMARY OF THE INVENTION

To this end, the invention proposes a device for welding a cap of a container suitable for containing a medicinal substance, the device comprising a laser for welding the container, a barrel defining a laser firing chamber, the barrel being movable between multiple positions including a container welding position and an unloaded position, a laser shutter, the barrel opening the shutter in the welding position and closing the shutter in the unloaded position. The device may also comprise a skirt suitable for preventing or allowing the barrel to move between the unloaded position and the welding position.

In one embodiment, the shutter is movable in rotation and/or the barrel is mobile in translation.

According to one embodiment, the device also comprises means for converting the translation of the barrel into a rotation of the shutter.

According to one embodiment, the conversion means comprise a rack secured to the barrel and a toothed wheel driven by the rack, the shutter being secured to the toothed wheel.

In one embodiment, the closure of the shutter by the barrel places the shutter in a closed state across the firing direction of the laser.

In one embodiment, the opening of the shutter by the barrel places the shutter in an open state in a wall of the barrel.

In one embodiment, the shutter is inaccessible from outside the device.

In one embodiment, the barrel is mobile in translation against a spring.

In one embodiment, the spring biases the barrel towards the unloaded position.

According to one embodiment, the device also comprises sensors for detecting the opening and closing of the shutter, the detection of the opening or closing of the shutter allowing or prohibiting firing by the laser.

According to one embodiment, a sensor for detecting the opening of the shutter and a sensor for detecting the closure of the shutter are actuated by different elements of the device, preferably a sensor for detecting the opening of the shutter is actuated by the barrel and a sensor for detecting the closure of the shutter is actuated by the shutter.

According to an embodiment, the skirt is able to prevent the passage of the barrel between the unloaded position and the welding position if the device is incorrectly positioned with respect to the container or is able to allow the passage of the barrel between the unloaded position and the welding position if the device is correctly positioned with respect to the container.

In one embodiment, the skirt is a centring cylinder on a container to be welded.

In one embodiment, the device also comprises ventilation orifices.

According to one embodiment, orifices carried by a housing of the device are facing the orifices of the barrel in the unloaded position of the barrel and are closed in the welding position of the barrel.

According to one embodiment, the device also comprises a suction system suitable for sucking fumes through the orifices

The invention also relates to a method of welding a cap of a container suitable for containing a medicinal substance, the method comprising the steps of providing a device as previously described with the barrel in an unloaded position, positioning the device on a container, and welding the cap of the container.

According to an embodiment, the device further comprises a sensor for detecting the opening of the shutter and a sensor for detecting the closure of the shutter, the firing of the laser being possible if the sensor for detecting the opening of the shutter detects the opening of the shutter and/or if the sensor for detecting the closure of the shutter does not detect that the shutter is closed; the firing of the laser being prohibited if the sensor for detecting the opening of the shutter does not detect the opening of the shutter and/or if the sensor for detecting the closure of the shutter detects that the shutter is closed.

According to one embodiment, after welding the cap of a container, the device is moved for positing on another container, with the firing of the laser prohibited by the barrel in the unloaded position.

In one embodiment, the device is secured to a robotic arm.

According to an embodiment, the skirt is able to prevent the passage of the barrel between the unloaded position and the welding position if the device is in an incorrect position relative to the container or is able to allow the passage of the barrel between the unloaded position and the welding position if the device is in a correct position relative to the container.

According to one embodiment, the device comprises ventilation orifices and the method comprises a fume ventilation step.

According to one embodiment, the method comprises, between two container welding steps, the ventilation of the device through the facing orifices, and during a welding step, sealing the inside of the device by shutting the orifices.

According to one embodiment, the ventilation of fumes is carried out by suction of the fumes.

The use of the verb “comprise” and its variants, as well as its conjugations in this document, may not in any way exclude the presence of elements other than those mentioned. The use in this document of the indefinite article “a”, “an”, or the definite article “the” to introduce an element does not exclude the presence of a plurality of these elements.

The terms “first”, “second”, etc. are used in the context of this document exclusively to differentiate between different elements, without implying any order between these elements.

All the preferred embodiments and all the advantages of the welding device according to the invention apply mutatis mutandis to the present method, and vice versa. The various embodiments may be considered individually or in combination.

### BRIEF DESCRIPTION OF THE FIGURES

Further characteristics and advantages of the present invention will become apparent from the following detailed description, for the understanding of which reference is made to the attached figures which show:

FIG. 1 shows a schematic view of an example of a device for welding a container without a container;

FIG. 2, a schematic view of the device in FIG. 1 with a container

FIG. 3, a schematic view of another aspect of the device;

FIG. 4, a schematic view of the device in FIG. 3 with a container.

The drawings in the figures are not to scale. Similar elements are generally denoted by similar references in the figures. In the scope of this document, the same or similar elements may have the same references. Furthermore, the presence of reference numbers or letters in the drawings may not be considered as limiting, even when these numbers or letters are indicated in the claims.

### DETAILED DESCRIPTION OF EMBODIMENTS OF THE INVENTION

The invention relates to a device for welding a cap of a container suitable for containing a medicinal substance. The device comprises a laser for welding the container and a barrel defining a laser firing chamber. The barrel is movable between several positions, including a welding position of the container and an unloaded position. The device also comprises a laser shutter, with the barrel opening the shutter in the welding position and closing the shutter in the unloaded position. In this way, when the barrel is in the unloaded position, the shutter prevents laser fire from coming from the device, making it safer.

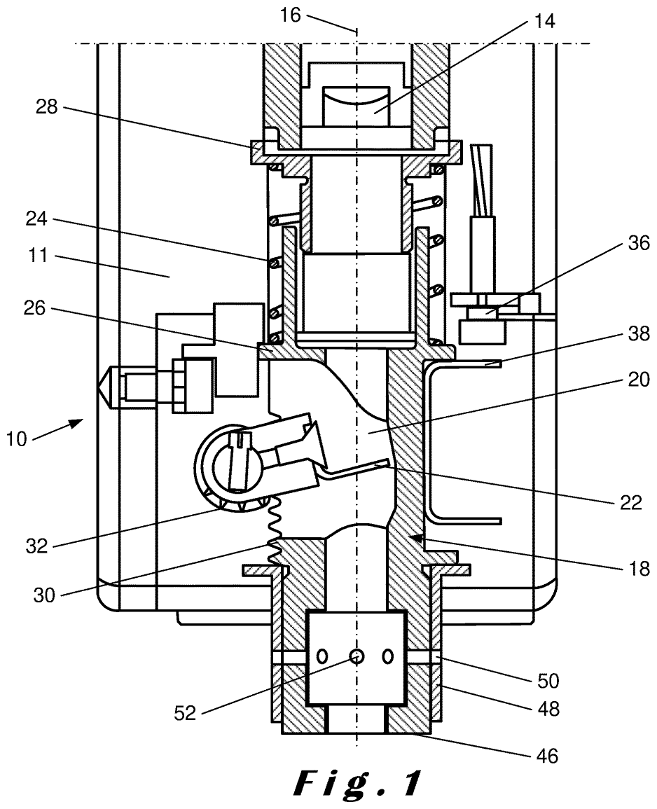

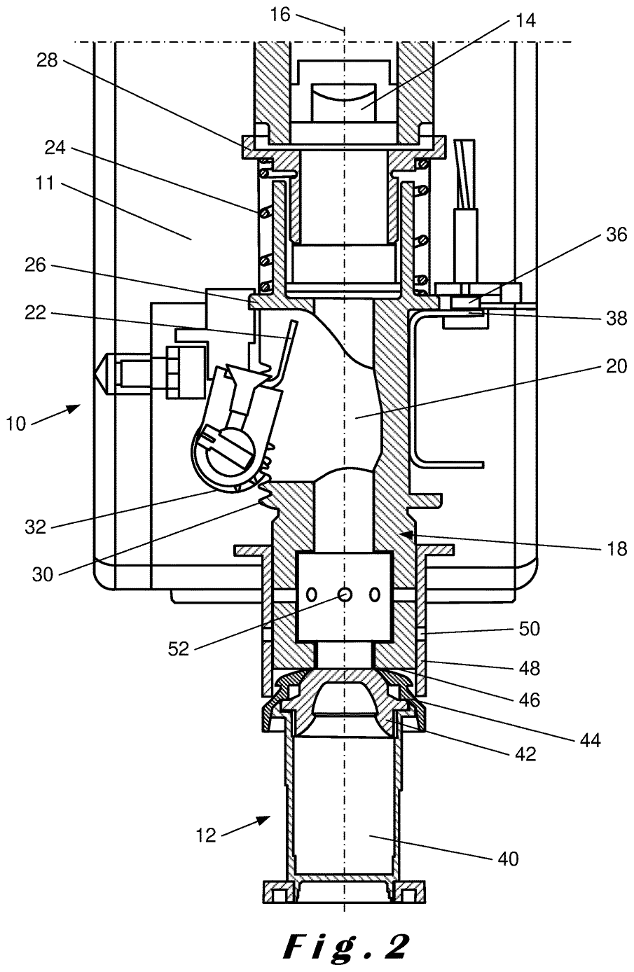

FIG. 1 illustrates a schematic view of an example of a device 10 for welding a cap of a container, without the presence of a container. FIG. 2 shows a schematic view of the device 10 in FIG. 1 with the presence of a container 12.

The container 12 is suitable for holding a substance, which may be a medicinal or pharmaceutical substance. The use in this document of the expression “medicinal substance” or “pharmaceutical substance” covers both any type of medication, whether chemical or biological, or any ingredient intended to be incorporated into the formulation of a drug, as well as all other biological substances requiring low-temperature storage, such as cells for example. The substance is preferably fluid or liquid. The substance can be intended to be injected into the body of a patient, human or animal, for example with a syringe. The substance can be injected into the patient all at once, or continuously. The container can receive a predefined quantity of medicinal substance. For example, the container may receive a single dose of substance. The quantity of substance then corresponds to what is intended to be administered to the patient at one time.

By way of example, the container 12 shown in FIG. 2 comprises a bottle 40, suitable for containing the substance. The bottle 40 is closed by a cap 42. The cap 42 may be surmounted by a ring 44. The ring 44 attaches the cap 42 to the bottle 40. This container structure could be different. Initially, the container 12 may be supplied empty with the cap 42 (and, if applicable, the ring 44) in place. The container and the air contained in the container 12 may have been sterilised beforehand, for example by exposure to ionising radiation. The substance can be introduced into the bottle 40 through the cap 42 using a needle-the piercing is preferably in a precise area of the cap 42. Once the substance has been introduced, the needle is withdrawn from the cap. The cap can be closed naturally lip to lip. The device 10 enables the cap to be laser-welded to make it re-seal it and prevent contamination of the inside of the container, and therefore of the substance, over time. The cap 42 is made of a material that absorbs the laser energy, creating a weld in the cap 42 that seals the inside of the container 12.

According to FIGS. 1 and 2, device 10 comprises a housing 11 and a laser 14. The laser is suitable for emitting a shot in one direction along an axis 16. The laser shot is intended to exit the device 10, in order to weld the cap 42 of the container 12 positioned in the direction of the laser shot. The laser allows to weld the cap 42 of the container 12 after the introduction needle of the substance has been removed, to ensure that the cap is sealed again and to guarantee sterility over time. The weld occurs over part of the thickness of the cap. The laser energy is progressively absorbed by the material of the cap 42 and the weld is made on the surface of the cap 42, on the side of the incident laser beam. The absorbency of the material of the cap is calibrated so that the energy of the laser beam is totally absorbed within the thickness of the cap and the laser beam does not pass through the cap 42 so as not to harm the substance. The weld is sufficiently thick to restore the seal of the cap while ensuring sufficient mechanical strength. The weld occurs, for example, over half the thickness of the cap 42 or less. For example, the weld could be between 0.4 and 1 mm thick for a 2 mm thick cap.

The device 10 comprises a barrel 18 defining a laser firing chamber 20. Such a barrel 18 provides the link between the laser 14 and the container 12. The barrel 18 is used to connect to a fibre that can deliver the laser 14 and to connect to the container 12. This creates a contact interface with the container 12 that is independent of the fibre that delivers the laser.

The barrel 18 can be moved between several positions relative to the housing 11. FIG. 1 shows the barrel in an unloaded position and FIG. 2 shows the barrel in a welding position. Other positions are possible, in particular intermediate positions between these positions, or upper and lower abutment positions, beyond the unloaded and welding positions. The unloaded position corresponds to the position in which no container is present. This may correspond to a rest position of the device 10, at the end of welding a container. This may correspond to moving the device 10 to position it on another container to be welded. The welding position corresponds to the position in which a container is present and in which the device is able to pull. This may correspond to an operating position of the device 10. According to FIGS. 1 and 2, the unloaded position corresponds to a low position of the barrel and the welding position to a high position of the barrel. The barrel 18 can be retracted further into the housing 11 in the welding position than in the unloaded position. The advantage of the different positions is that the shot is fired when the barrel 18 is in a safer position relative to the environment.

The device 10 also comprises a laser shutter 22. In the welding position, the barrel 18 opens the shutter 22 (the shutter is in an open state). In the unloaded position, the barrel 18 closes the shutter 22 (the shutter is in a closed state). This allows operators to be protected against unintentional firing of the laser, which could be hazardous to their health. In particular, the contact of the laser with an operator's skin or eyes could present a danger to the operator. In this way, by placing the shutter 22 in the closed state in the unloaded position-i.e. in the absence of a container, when the device is not ready to weld-any risk of danger is prevented. In addition, the shutter 22 is preferably inaccessible from outside the device 10. This prevents the shutter 22 from being manipulated by an inexperienced operator. However, when the barrel 18 is placed in the welding position to weld the cap of a container, the shutter passes into the open state to allow the welding. The opening of the shutter is synchronised with the welding position of the barrel. This also avoids leaving the shutter closed during a welding operation and damaging the device.

The barrel 18 can be movable in translation along the axis 16 in the housing 11. This allows the barrel 18 to move parallel to the laser firing axis. The barrel 18 itself cannot therefore block the laser shot in an unfortunate way. The barrel 18 can also be movable in translation against a spring 24. This simplifies the movement of the barrel and makes the device safe. The spring 24 allows the barrel 18 to return to the unloaded position-shutter closed. This is advantageous because the shutter 22 is then closed when the device is not in use. According to the figures, the spring 24 can bias the barrel 18 downwards towards the unloaded position. The barrel can then be movable in translation vertically, from an unloaded position, upwards against the spring towards the welding position. When the barrel 18 is in the welding position, the spring 24 pushes the barrel 18 downwards and thus pushes the barrel 18 against the cap 42 of a container 12 positioned for welding. This ensures a good connection between the barrel 18 and the cap 42, and therefore confines the laser within the barrel 18. This prevents the laser from being reflected off the cap. This reduces the risk of laser burns to the operator. The spring 24 can also be interposed between a shoulder 26 on the barrel 18 and a shoulder 28 on the device 10. The shoulder 28 is fixed in position, allowing the shoulder 26 and the barrel 18 to be moved in translation, parallel to the axis 16.

The shutter 22 can be mobile in rotation. This limits the amount of space taken up by the device 10 when the shutter 22 is moved. The shutter 22 can be rotatably mounted on the housing 11, outside the barrel 18, and can enter the barrel 18 to shut off the laser shot. In one embodiment, the shutter 22 is actuated by the barrel 18 via means for converting the translation of the barrel 18 into a rotation of the shutter 22. The conversion means may comprise a connecting rod mechanism. They may also include a rack 30 driving a gear wheel 32. For example, the shutter 22 is secured to the toothed wheel 32 driven by the rack 30 secured to the barrel 18. The rack 30 and the wheel 32 provide a simple drive for the shutter 22 during movements of the barrel 18. The drive by toothed wheel and rack enables precise and simple synchronisation between the movements of the barrel 18 and the shutter 22.

The closure of the shutter 22 by the barrel 18 places the shutter in a closed state across the firing direction of the laser- or orthogonally to the axis 16. According to FIG. 1, the shutter 22 is in the closed state in the direction that the shutter prevents the passage of the laser beam, making the device safer. The barrel 18 may comprise a central bore along the axis 16 defining the laser firing chamber 20 along the barrel. Advantageously, the shutter 22 is a disk that follows the cross-section of the chamber. This allows the chamber 20 to be properly shut off.

The opening of the shutter 22 by the barrel 18 places the shutter in an open state, parallel to the wall of the barrel. According to FIG. 2, the shutter 22 is in the open state in the sense that the shutter no longer prevents the laser beam. In the open state, the shutter 22 is clear of the laser's firing range. The shutter 22 then allows the laser beam to pass through, enabling welding to take place. In the open state, the shutter can replace the barrel wall so that it is retracted out of the laser's firing range.

The device 10 can also include sensors for detecting the opening and closing of the shutter 22. The detection of the opening or closing of the shutter 22 allows or prohibits the firing of the laser. This increases safety when using the device 10. In one aspect, the sensor for detecting the opening must detect an opening of the shutter 22 to allow firing. Conversely, if the sensor for detecting the closure detects a closure of the shutter 22, firing is prohibited. In another aspect, the information from the two sensors can be combined to allow or prohibit firing. In this way, firing authorisation can be given if the sensor for detecting the opening detects the opening of the shutter and if the sensor for detecting the closure does not detect the closure of the shutter (or in other words, does not deliver a closing signal). Conversely, the shot is prohibited if the sensor for detecting the closure detects that the shutter is closed and the detection sensor does not detect that the shutter is open (or in other words, does not deliver an open signal). In the event of conflicting signals, the firing is prohibited. The combination of the two signals enhances the safety of the device by compensating for the failure of one of the sensors.

In particular, the device 10 may comprise a sensor 36 for detecting the opening of the shutter 22, visible in the figures, and a sensor (not visible in the figures) for detecting the closure of shutter 22.

For example, the sensor 36 for detecting the opening of the shutter 22 is actuated by the barrel 18. Thus, the movements of the barrel 18 trigger the sensor 36. This synchronises the positions of barrel 18 with the activation of the sensor. More specifically, the barrel 18 can actuate the sensor 36 when the barrel 18 is in the welding position, in order to trigger a signal indicating that the barrel is in the welding position and that firing is allowed—otherwise, the sensor does not deliver a signal, indicating that the barrel is in the unloaded position or, in any case, not in the welding position. In FIG. 2, the barrel 18 is in the welding position, enabling the sensor 36 to be actuated—and therefore allowing firing. In FIG. 1, the barrel 18 is in the unloaded position, preventing the sensor 36 from being actuated—and therefore possibly preventing the laser from firing. It is conceivable that the barrel 18 comprises an index 38 for actuating the sensor 36. According to FIG. 2, the index 38 actuates the sensor 36. It is also possible that the sensor detecting the opening of the shutter 22 is actuated by the shutter 22 itself. For example, when the shutter 22 is in the open state, the shutter 22 actuates the sensor for detecting the opening of the shutter 22. It is conceivable that the shutter 22 comprises an index (not visible in the figures) enabling actuation of the sensor detecting the opening of the shutter 22.

By way of example, the sensor for detecting the closure of the shutter 22 can be actuated by the shutter 22. Thus, the movements of the shutter 22 therefore trigger the closure detection sensor. This allows the shutter positions to be synchronised with the actuation of the closure sensor. More specifically, the shutter 22 can actuate the sensor when the shutter 22 is in the closed state, in order to trigger a signal indicating that the shutter 22 is in the closed state and that firing is prohibited—otherwise, the sensor does not deliver a signal, indicating that the shutter is in the open state or, in any case, not in the closed state. In FIG. 1, the shutter is in the closed state, enabling the closure detection sensor to be activated. In FIG. 2, the shutter is in the open state, preventing actuation of the closure sensor—and therefore possibly enabling actuation of the laser. It is conceivable that the shutter 22 comprises an index (not visible in the figures) enabling actuation of the sensor for detecting the closure of the shutter 22. It is also possible that the sensor for detecting the closure of the shutter 22 is actuated by the barrel 18. For example, when the barrel 18 is in the unloaded position, the barrel 18 activates the sensor for detecting the closure of the shutter 22. It is conceivable that the barrel 18 comprises an index similar to the index 38 (visible in the figures below the index 38, on the same profiled part, but without reference) enabling the actuation of the sensor for detecting the closure of the shutter 22.

Preferably, the sensor for detecting the closure of the shutter 22 and the sensor for detecting the opening of the shutter 22 are each associated with the movements of two different members of the device (for example the barrel 18 and the shutter 22). The fact that each sensor is associated with the movements of two different members and that the signals from both sensors are taken into account increases the safety of the device. If one of the sensors fails and/or if one of the members fails to move, this can lead to contradictory signals—and the firing laser is then prohibited for safety reasons, to avoid any accidental firing.

The state of the signals emitted by the two sensors can advantageously be combined with the spatial position of the device 10, this device being secured to a robotic arm, for example. When the device 10 is not positioned in space at a point where the barrel 18 is likely to be actuated by a container 12, the sensor 36 which indicates the open position of the shutter 22 cannot be actuated while the sensor which indicates the closed position of the shutter 22 is actuated.

In the welding position, the device 10 is in contact with the container 12. To be in precise contact with the container 12, the housing 11 comprises a skirt 48. The skirt 48 can fit around the shape of the cap 42 of the container. The skirt 48 projects from the device 10. The skirt 18 is immobile with respect to the housing. The skirt 48 surrounds a lower part of the barrel 18. The barrel 18 is movable in translation along the skirt 48. The skirt 48 can be a safety skirt. The skirt is a safety skirt that prevents the laser from firing if the device is incorrectly positioned. The skirt is a safety skirt that prevents the laser from firing if the device is incorrectly positioned in relation to a container. Incorrect or correct positioning means, for example, relative positioning between the device and the container. Incorrect positioning also means incorrect positioning by shifting the device in relation to a container, or incorrect positioning in the absence of a container, in relation to the environment. The skirt 48 prevents firing if the device 10 (and therefore the barrel 18) is incorrectly positioned. The skirt 48 prevents firing if the device 10 (and therefore the barrel 18) is incorrectly positioned in relation to the container 12, and in particular the cap 42. The skirt 48 can form an abutment against the barrel changing position. The skirt 48 can form an abutment to prevent the barrel from passing between the unloaded position and the welding position. The skirt 48 is designed to prevent the barrel from passing between the unloaded position and the welding position. The skirt 48 is designed to prevent the barrel from passing between the unloaded position and the welding position if the device is incorrectly positioned. The skirt 48 is designed to prevent the barrel from passing between the unloaded position and the welding position if the device is incorrectly positioned in relation to the container. The skirt 48 is able to prevent or allow the passage of the barrel between the unloaded position and the welding position. The skirt 48 can prevent the barrel from passing between the unloaded position and the welding position if the device is incorrectly positioned, particularly in relation to the container, or can allow the barrel to pass between the unloaded position and the welding position if the device is correctly positioned, particularly in relation to the container. If the container 12 and the device 10 are correctly positioned relative to each other, the skirt 48 correctly surrounds the cap 42 and one end 46 of the barrel rests against the cap 42. The container 12 biases the end 46, causing the barrel 18 to move, for example vertically in relation to the skirt 48. The skirt 48 allows the barrel to pass between the unloaded position and the welding position. In FIG. 2, the barrel 18 is translated vertically upwards. Translating the barrel 18 then allows the change of state of the shutter 22, towards the open state (or welding position of the barrel). The sensors enable the laser to be fired. If the container 12 and the device 10 are not properly positioned (i.e. incorrectly positioned) relative to each other, the skirt 48 does not properly surround the cap 42. The container 12 does not stress the end 46 of the barrel 18 and does not cause the barrel 18 to move. The skirt 48 strikes the container 12, and in particular the cap 42. The skirt 48 prevents the passage of the barrel between the unloaded position and the welding position. The shutter 22 remains in its closed state (or rest position of the device and unloaded position of the barrel). The skirt 48 may surround the barrel—and in particular near the lower end of the barrel—the barrel being movable relative to the skirt 48. The skirt 48 prevents the movement of the barrel 18 towards the inside of the device if the device 10 is incorrectly positioned, particularly in relation to the container (relative positioning). The skirt 48 allows the barrel 18 to move towards the inside of the device if the device 10 is correctly positioned, particularly in relation to the container. If the device 10 is not correctly centred on the container, the skirt 48 prevents the movement of the barrel 18 towards the inside of the device. The skirt 48 therefore increases the safety of the device 10 by preventing accidental firing if the device 10 is not correctly positioned. Also, in the absence of a container 12, the device could come to rest against an element in the environment, which would correspond to incorrect positioning. The skirt 48 then prevents the passage of the barrel between the unloaded position and the welding position (by forming an abutment) and therefore prevents the shutter 22 from passing from the closed state to the open state.

In addition, the skirt 48 can ensure precise centring of the device with respect to the container; the skirt 48 precisely bears against the container 12—or on the ring 44 in the example of the container in FIG. 2—a nd the barrel is applied precisely against the container 12—on the cap 42 in the example of the container in FIG. 2. The skirt 48 can be a cylinder for centring the device 10 relative to the container 12. The skirt 48 provides a laser-tight seal between the inside of the device 10 and the outside, preventing the laser from escaping through reflection on the cap. The skirt also enables welding to be carried out at the point where the needle pierces the cap. Thus, the device 10 both improves safety and ensures high-quality welding.

The device 10 may also comprise ventilation orifices 50, 52, as shown in FIGS. 1 and 2. The orifices 50, 52 allow ventilation of the interior of the device 10. Preferably, the ventilation takes place between two firings, or in other words, between the welding of two containers 12. In this way, fumes caused by welding a cap during a fire are evacuated through the orifices 50, 52 before the next fire. More specifically, the skirt 48 can be provided with orifices 50 on a circumference of the skirt 48 and the barrel 18 with orifices 52 near the end 46, on the circumference of the barrel. In the unloaded position of barrel 1 in FIG. 1, the orifices 50 and 52 face each other. So, in the absence of a container 12, the facing orifices 50 and 52 allow the smoke generated by the previous shot to be released. In the welded position of the barrel 18 in FIG. 2, the orifices 50, 52 are no longer facing each other. Due to the movement of the barrel 18 resting on the container 12, the orifices 50, 52 are axially offset with respect to each other. The orifices 50 are shut off by the barrel 18 and the orifices 52 are shut off by the skirt 48. This ensures the laser to be sealed between the inside of the device 10 and the outside. In addition, a suction of the smoke can be provided in combination with the orifices.

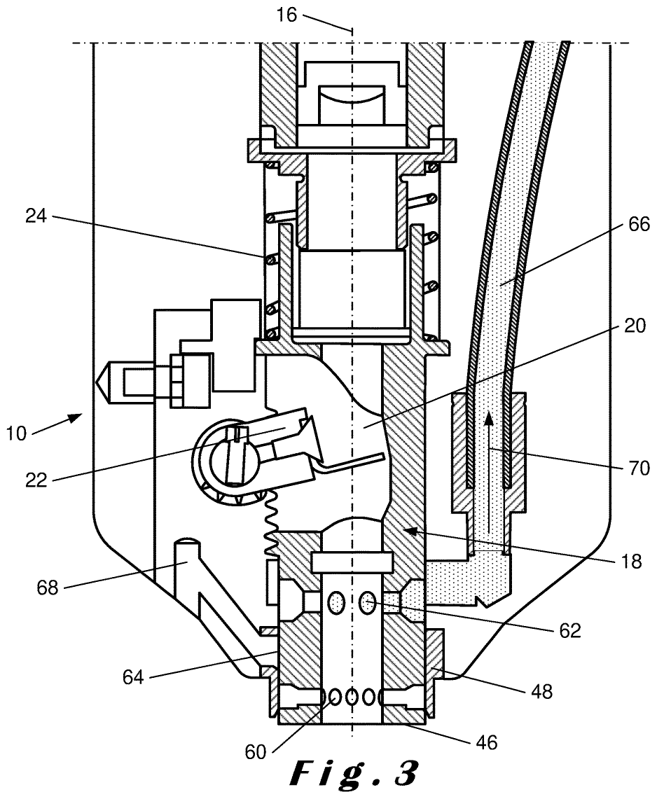

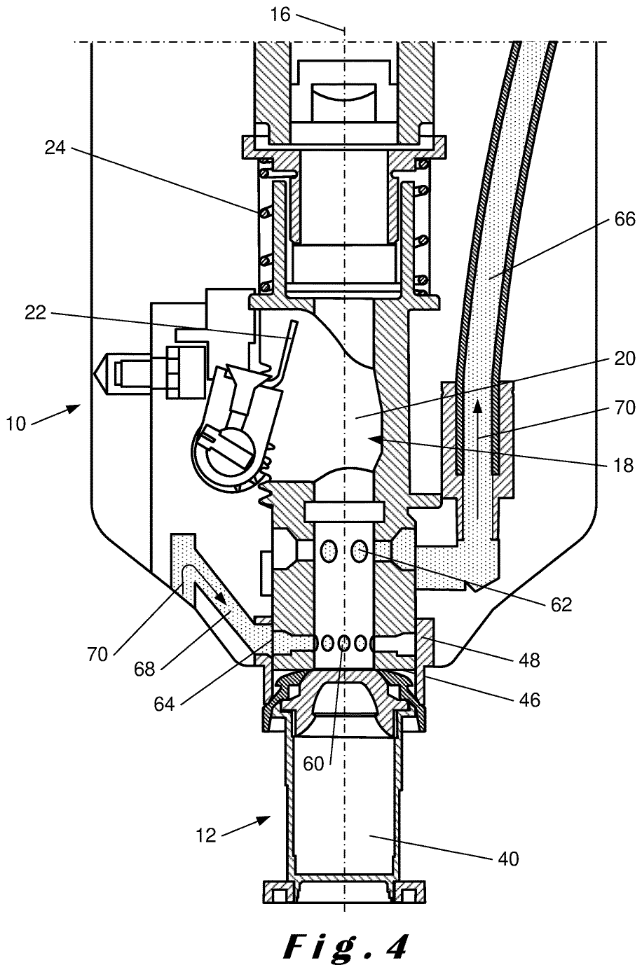

FIGS. 3 and 4 show another example of ventilation orifices 60, 62, 64. The barrel 18 may comprise orifices 60 near its end 46, and orifices 62 further inwards of the device 10. A suction 66 is designed to suck fumes through orifices 62. More specifically, the suction 66 can always be at least partly facing the orifices 62, whatever the position of the barrel 18 (unloaded or welding). A lateral air inlet 68 is provided to allow ambient air to enter the device 10. Orifices 64 in the skirt 48 are able to connect the air inlet 68 with the inside of the barrel 18, when the barrel is in the welding position. The orifices 64 are shut off when the barrel is in the unloaded position. When the barrel is released (in the unloaded position), the air enters through the main outlet orifice of the barrel, since there is no container, and is sucked through the suction 66. This ventilates the barrel well between the firings. When the container is in place and pushes on the barrel to return it to the welding position shown in FIG. 4 (barrel up), this frees the air inlet 68 because the orifices 60 are facing the orifices 64 in the skirt 48. This allows an air flow to enter the device 10 through the air inlet 68, to pass through the orifices 64, 60 in the barrel and then to be evacuated through the orifices 62 to the suction 66. In this way, the fume is also evacuated during the firing (welding). The air flow is shown by arrows 70. This allows the device 10 to be continuously ventilated. The air inlet 68 can be designed to trap any reflections from the laser, preventing them from leaving the barrel. The shape of the air inlet 68 may allow such a trap. For example, the air inlet 68 is angled. The skirt 48 also allows the laser to be sealed between the inside of the device and the outside, in the sense that the laser is prevented from escaping through reflection on the cap. The suction 66 can also be arranged as shown in the embodiment of FIGS. 1 and 2.

The invention also relates to a method of welding the container 12, the container being suitable for containing the medicinal substance. The method comprises providing the device 10 with the housing 18 in the unloaded position. Then, a container 12 is loaded in the continuation of the barrel—in line with the end 46. The device 10 is then placed in the welding position on the container. The device 10 and the container are moved towards each other. For example, the device is moved to the container. The device 10 moves closer to the container. If the device is incorrectly positioned, particularly in relation to the container, the skirt 48 forms an abutment, particularly against the container. The skirt 48 prevents the passage of the barrel between the unloaded position and the welding position. If the device is correctly positioned, particularly in relation to the container, the skirt 48 allows the barrel to pass between the unloaded position and the welding position. To this end, the skirt 48 is applied around the container 12 (and more precisely, the cap 42), which also enables the device 10 to be centred relative to the container and the end 46 to be applied precisely against the cap. The method then comprises a step in which the container 12 is welded using a firing of the laser. In the unloaded position, the shutter 22 is in the state shown in FIG. 1, i.e. closed. In the welding position, the shutter 22 is in the state shown in FIG. 2, i.e. open. According to one aspect, the firing of the laser is possible if the sensor for detecting the opening of the shutter detects the opening of the shutter and the sensor for detecting the closure of the shutter does not detect the closure of the shutter. The firing of the laser is prohibited if the sensor for detecting the opening of the shutter does not detect the opening of the shutter and if the sensor for detecting the closure of the shutter detects the closure of the shutter. The method enables a series of containers to be welded together; to do this, the device is moved to position itself on another container with the laser shot prevented by the barrel in the unloaded position. The method may comprise one or more steps of ventilation of the fumes through orifices 50, 52, 60, 62 and 66. The ventilation through the orifices can be natural or by suction of the fumes. For example, between two container welding steps, the device is ventilated through the facing orifices 50, 52. The suction 66 can evacuate fumes during the container welding and/or between two welding steps. During a welding step, the seal inside the device 10 is ensured by shutting off the orifices 50, 52 or by the shape of the air inlet 68. The advantages of the device are applicable to the method and vice versa.

The invention therefore concerns a device and a method for welding a cap of a container suitable for containing a medicinal substance. The device may comprise a plurality of security elements which may be taken individually or in combination to further enhance security:
the shutter 22 can be in an open or closed state,
the skirt 48 is able to (form an abutment to) prevent the passage of the barrel between the unloaded position and the welding position or to allow the passage of the barrel between the unloaded position and the welding position,
the skirt 48 can allow a laser to be sealed between the inside of the device and the outside, in the sense that it prevents the laser from being reflected off the cap,
sensors for detecting the opening of the shutter and for detecting the closure of the shutter, possibly actuated by different elements of the device.

The present invention has been described above in connection with specific embodiments, which are illustrative and should not be considered limiting. In general, it will be apparent to a person skilled in the art that the present invention is not limited to the examples illustrated and/or described above. For example, the sensors detecting the opening and closing of the shutter can be actuated by the barrel and the shutter respectively, or vice versa.

1. A device for welding a cap of a container suitable for containing a medicinal substance, the device comprising:
a laser for welding the container;
a barrel defining a laser firing chamber, the barrel being movable between multiple positions including a container welding position and an unloaded position;
a laser shutter, the barrel opening the laser shutter in the welding position and closing the laser shutter in the unloaded position; and
a skirt suitable for preventing or allowing the barrel to move between the unloaded position and the welding position.

2. The device according to claim 1, wherein the laser shutter is movable in rotation and/or the barrel is mobile in translation.

3. The device according to claim 1, further comprising means for converting a translation of the barrel into a rotation of the laser shutter.

4. The device according to claim 3, wherein the conversion means comprise a rack secured to the barrel and a toothed wheel driven by the rack, the laser shutter being secured to the toothed wheel.

5. The device according to claim 1, wherein the closure of the laser shutter by the barrel places the laser shutter in a closed state across a firing direction of the laser.

6. The device according to claim 1, wherein the opening of the laser shutter by the barrel places the laser shutter in an open state in a wall of the barrel.

7. The device according to claim 1, wherein the laser shutter is inaccessible from outside the device.

8. The device according to claim 1, wherein the barrel is mobile in translation against a spring.

9. The device according to claim 8, wherein the spring biases the barrel towards the unloaded position.

10. The device according to claim 1, further comprising sensors for detecting the opening and closing of the laser shutter, the detection of the opening or closing of the laser shutter allowing or prohibiting firing by the laser.

11. The device according to claim 10, wherein a sensor for detecting the opening of the laser shutter and a sensor for detecting the closure of the laser shutter are actuated by different elements of the device, preferably a sensor for detecting the opening of the laser shutter is actuated by the barrel and a sensor for detecting the closure of the shutter is actuated by the laser shutter.

12. The device according to claim 1, wherein the skirt is able to prevent a passage of the barrel between the unloaded position and the welding position if the device is incorrectly positioned relative to the container, or is able to allow the passage of the barrel between the unloaded position and the welding position if the device is correctly positioned relative to the container.

13. The device according to claim 1, wherein the skirt is a centring cylinder on the container to be welded.

14. The device according to claim 1, further comprising ventilation orifices.

15. The device according to claim 14, wherein orifices carried by a housing of the device are facing the orifices of the barrel in the unloaded position of the barrel and are closed in the welding position of the barrel.

16. The device according to claim 14, further comprising a suction suitable for sucking fumes through the orifices.

17. A method for welding a cap of a container suitable for containing a medicinal substance, the method comprising:
providing a device comprising:
a laser for welding the container;
a barrel defining a laser firing chamber, the barrel being movable between multiple positions including a container welding position and an unloaded position;
a laser shutter, the barrel opening the laser shutter in the welding position and closing the laser shutter in the unloaded position; and
a skirt suitable for preventing or allowing the barrel to move between the unloaded position and the welding position,
the barrel being in the unloaded position,
positioning the device of the container; and
welding the cap of a container.

18. The method according to claim 17, the device further comprising a sensor for detecting the opening of the laser shutter and a sensor for detecting the closure of the laser shutter, wherein
the firing of the laser is possible if the sensor for detecting the opening of the laser shutter detects the opening of the laser shutter and/or if the sensor for detecting the closure of the laser shutter does not detect that the laser shutter is closed; and
the firing of the laser is prohibited if the sensor for detecting the opening of the laser shutter does not detect the opening of the laser shutter and/or if the sensor for detecting the closure of the laser shutter detects that the laser shutter is closed.

19. (canceled)

20. (canceled)

21. The method according to claim 17, wherein, at the positioning step, the skirt is able to prevent a passage of the barrel between the unloaded position and the welding position if the device is in an incorrect position relative to the container or is able to allow the passage of the barrel between the unloaded position and the welding position if the device is in a correct position relative to the container.

22. The method according to claim 17, the device comprising ventilation orifices, and the method comprising a fume ventilation step.

23. (canceled)

24. (canceled)
